(19) United States
(12) Patent Application Publication
(10) Pub. No.: US 2008/0150249 A1
(43) Pub. Date: Jun. 26, 2008

(54) Trailing Arm Type Suspension Structure

(75) Inventor: Satoshi Murata, Aichi-ken (JP)

Correspondence Address: OBLON, SPIVAK, MCCLELLAND MAIER & NEUSTADT, P.C., 1940 DUKE STREET, ALEXANDRIA, VA, 22314, US

(73) Assignee: TOYOTS JIDOSHA KABUSHIKI KAISHA, Toyota-shi (JP)

(21) Appl. No.: 11/815,715

(22) PCT Filed: Dec. 6, 2006
(86) PCT No.: PCT/IB2006/003487

§ 371 Date: Aug. 7, 2007

(30) Foreign Application Priority Data
Dec. 8, 2005 (JP) 2005-354534

(51) Int. Cl. B60G 21/05

(52) U.S. Cl. 280/124.128; 280/124.116

(57) ABSTRACT

In a vehicular trailing arm type suspension structure, a trailing arm is formed by arranging and joining a first half trailing arm plate member and a second half trailing arm plate member in a longitudinal direction. The first half trailing arm plate member and the second half trailing arm plate member are formed so that, when they are joined, a predetermined length portion in the trailing arm relatively close to a vehicle body-side end of the trailing arm in the longitudinal direction has a hollow shape, and a predetermined length portion in the trailing arm relatively close to a wheel-side end of the trailing arm in the longitudinal direction is platy so as to allow a use as an axle bearing mount surface.

### BACKGROUND OF THE INVENTION

1. Field of the Invention

The invention relates to a vehicular trailing arm type suspension structure. In particular, the invention relates to a trailing arm type suspension structure that has achieved a weight reduction.

2. Description of the Related Art

A related-art vehicular trailing arm type suspension structure for use, in particular, as a rear suspension, is known (see, for example, Japanese Patent Application Publication No. JP-A-2005-8123).

Japanese Patent Application Publication No. JP-A-2005-8123 discloses a suspension structure in which an axle carrier through which an axle is to be passed is fixed by welding to a trailing arm.

However, according to the related-art structure disclosed in Japanese Patent Application Publication No. JP-A-2005-8123, since the axle carrier, a component separate from the trailing arm, is welded to the trailing arm, the weight correspondingly increases. Weight increase can be a factor for cost increase.

### SUMMARY OF THE INVENTION

It is a main object of the invention to provide a trailing arm type suspension structure that achieves weight reduction.

A first aspect of the invention relates to a vehicular trailing arm type suspension structure. In this vehicular trailing arm type suspension structure, a trailing arm is formed by arranging and joining a first half trailing arm plate member and a second half trailing arm plate member in a longitudinal direction. The first half trailing arm plate member and the second half trailing arm plate member have been formed so that, when the first half trailing arm plate member and the second half trailing arm plate member are joined, a predetermined length portion in the trailing arm relatively close to a vehicle body-side end of the trailing arm in the longitudinal direction has a hollow shape, and a predetermined length portion in the trailing arm relatively close to a wheel-side end of the trailing arm in the longitudinal direction is platy so as to allow a use as an axle bearing mount surface.

In this first aspect, the first half trailing arm plate member and the second half trailing arm plate member are fixed by, for example, welding.

More concretely, for example, in this first aspect, a cross-sectional shape of the first half trailing arm plate member is, for example, a generally square U shape. A cross-sectional shape of the second half trailing arm plate member may change along the longitudinal direction from so as to be a reversed square U shape with respect to the first half trailing arm plate member at a hollow portion in a vehicle body side of the trailing arm and be a square U shape with respect to the first half trailing arm plate member at a platy portion in a wheel side of the trailing arm.

According to the first aspect, the axle bearing mount surface that functions equivalently to an axle carrier can be formed in the wheel-side end of the trailing arm. Therefore, a weight reduction is realized in comparison with the related-art structure in which a separate axle carrier is welded to the wheel-side end of a trailing arm.

Besides, by providing the suspension structure according to the first aspect, a space on the inner side of the platy portion in the lateral direction of the vehicle can be secured because no member in association with the trailing arm or the axle is disposed in the space. Therefore, that space can be utilized to dispose a drive shaft or route an ABS sensor harness, and the attainment of a common axle carrier in four-wheel drive vehicles and two-front-wheel drive vehicles, and improvement in the ease of the connector mating and demating can be realized.

Furthermore, according to the first aspect, by weld-fixing the first and second half trailing arm plate members along the trailing arm longitudinal direction, the axle bearing mount surface integrated into the trailing arm can be formed. Therefore, the welding operation is easy, and the production cost reduces in comparison with the related-art structure in which a tubular trailing arm is weld-fixed to a separate platy axle carrier.

Incidentally, in the first aspect, aiming at facilitating the production by simplifying the structure, the first half trailing arm plate member and the second half trailing arm plate member may be closely attached to each other. Or, aiming at enhancing the bending rigidity of the platy portion, a reinforcement member may be inserted so as to from a (preferably, substantially uniform) clearance between the first half trailing arm plate member and the second half trailing arm plate member.

A second aspect of the invention relates to a vehicular trailing arm type suspension structure in which a portion of a wheel-side end of a hollow tubular trailing arm is plastic-deformed into a platy portion usable as an axle bearing mount surface, by crushing the portion.

In the second aspect, the trailing arm is a pipe component, and the aforementioned portion thereof is crushed by, for example, a pressing process.

According to the second aspect, since the axle bearing mount surface that functions equivalently to the axle carrier is formed in the wheel-side end of the trailing arm, a weight reduction is achieved, in comparison with the related-art structure in which a separate axle carrier is welded to the wheel-side end of a trailing arm.

Besides, by providing the suspension structure according to the second aspect, a space on the inner side of the platy portion in the lateral direction of the vehicle can be secured because no member in association with the trailing arm or the axle is disposed in the space. Therefore, that space can be utilized to dispose a drive shaft or route an ABS sensor harness, and the attainment of a common trailing arm type suspension structure in four-wheel drive vehicles and two-front-wheel drive vehicles, and improvement in the ease of the connector mating and demating can be realized.

Furthermore, according to the second aspect, by forming a platy portion where an axle bearing can be mounted by crushing a portion of a pipe component by a pressing process or the like, the trailing arm and the axle bearing mount surface that is integrated into the trailing arm can be produced. Therefore, the welding operation becomes unnecessary and the production cost reduces, in comparison with the related-art structure in which a tubular trailing arm is weld-fixed to a platy axle carrier.

### BRIEF DESCRIPTION OF THE DRAWINGS

The foregoing and further objects, features and advantages of the invention will become apparent from the following description of preferred embodiments with reference to the accompanying drawings, wherein like numerals are used to represent like elements and wherein:

FIG. 1 is a schematic perspective view of a trailing arm of a trailing arm type suspension structure in accordance with a first embodiment of the invention;

FIG. 2 is a cross-sectional view taken on line II-II of FIG. 1;

FIG. 3 is a cross-sectional view taken on line III-III of FIG. 1; and

FIG. 4 is a cross-sectional view of a trailing arm of a trailing arm type suspension structure in accordance with a modification of the first embodiment of the invention, taken on III-III of FIG. 1 similarly to the cross-sectional view of FIG. 3.

FIG. 5 is a schematic perspective view of a trailing arm of a trailing arm type suspension structure in accordance with a modified example of the first embodiment of the invention.

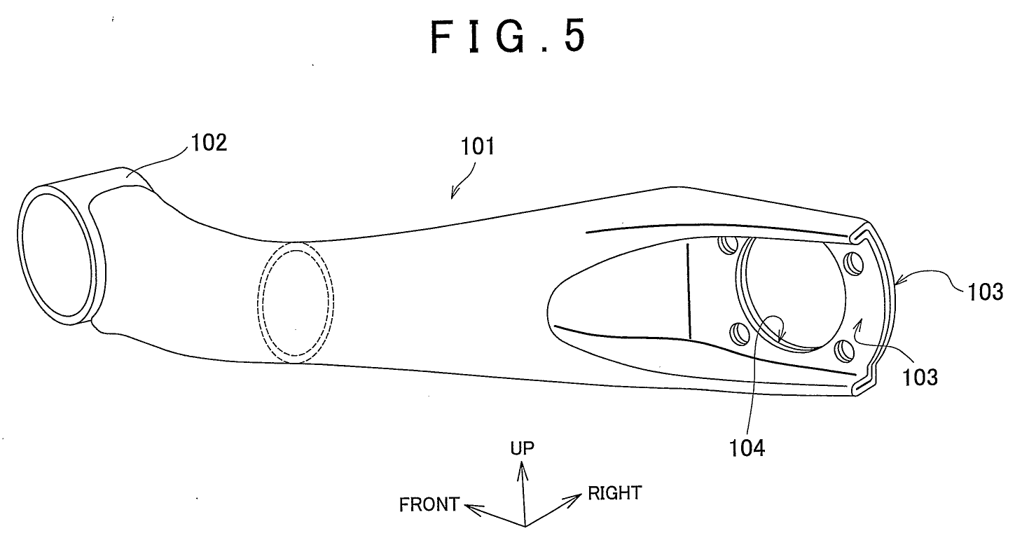

### DETAILED DESCRIPTION OF THE PREFERRED EMBODIMENTS

Embodiments of the invention will be described with reference to the accompanying drawings. It is to be noted herein that a basic concept, a major hardware construction, an operation principle, etc. of the trailing arm type suspension structure are already known to those with ordinary skill in the art, and therefore detailed description thereof will be omitted.

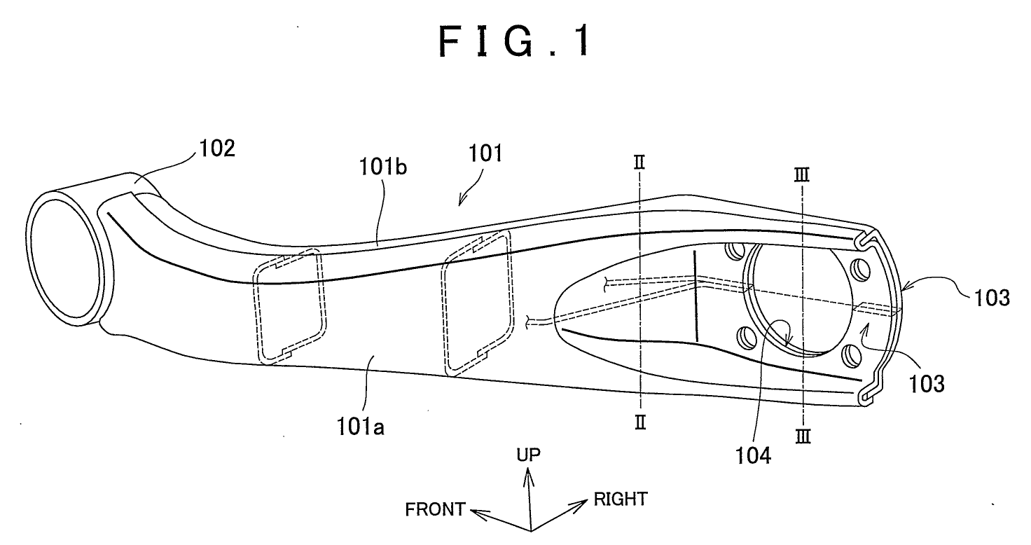

A trailing arm type suspension structure in accordance with a first embodiment of the invention will be described hereinafter with reference to FIGS. 1 to 3. In FIGS. 1 to 3, like component elements are denoted by the same reference characters. A structure for the right rear wheel will be described herein as an example.

FIG. 1 is a schematic perspective view of a trailing arm 101 of the trailing arm type suspension structure in accordance with of this embodiment, viewed from diagonally rearward inside the vehicle. For the sake of convenience, only the trailing arm 101 is shown while a vehicle body (frame), a wheel, an axle bearing that rotatably supports the wheel, etc. are omitted from the illustration.

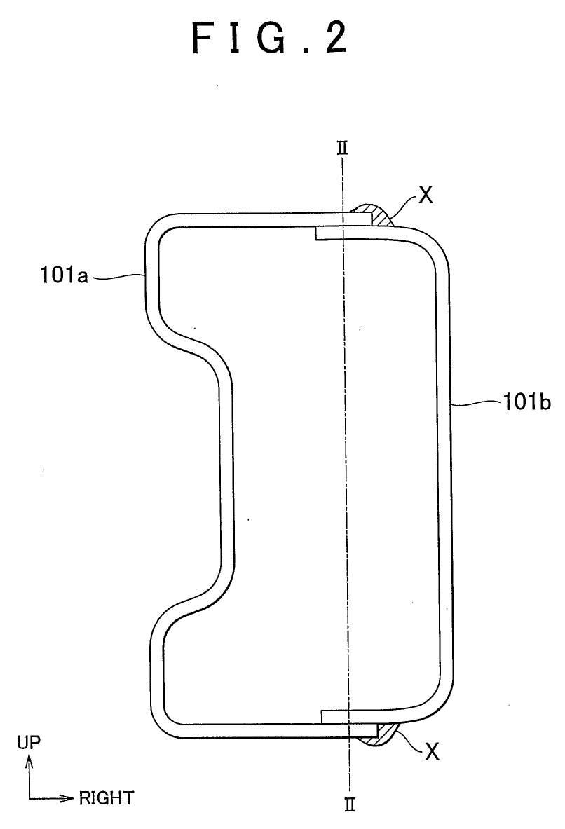

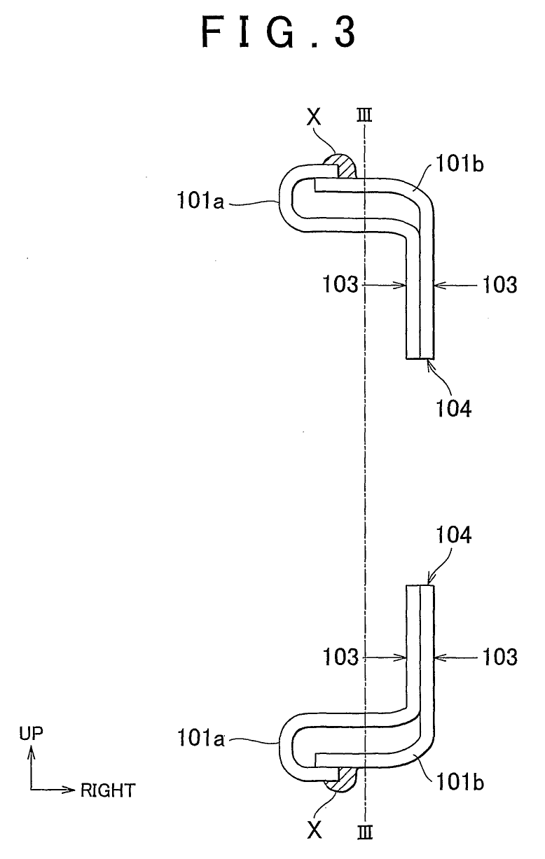

The trailing arm 101 in accordance with this embodiment has a structure that is formed by joining through welding (shown by characters X in FIGS. 2 and 3) a trailing arm inner plate member 101a (corresponding to a second half trailing arm plate member) that is formed, for example, into a generally square U shape by a pressing process, and a trailing arm outer plate member 101b (corresponding to a first half trailing arm plate member) that is formed, for example, also by a pressing process, so that the two members are arranged in parallel in the longitudinal direction.

As shown in FIG. 1, in a predetermined length region of the trailing arm 101 that is relatively close to the vehicle body-side end thereof, the trailing arm inner plate member 101a and the trailing arm outer plate member 101b are combined so that the open sides of the generally square U cross-sectional shapes thereof face each other, thus forming a hollow structure.

On the other hand, in a predetermined length region of the trailing arm 101 that is relatively close to the wheel-side end thereof, the cross-sectional shape of the trailing arm inner plate member 101a changes along the longitudinal direction of the trailing arm 101 as shown in FIG. 1.

Concretely, as shown in FIG. 2, showing a cross-sectional view taken on line II-II of FIG. 1, in the generally square U-shape section of the trailing arm inner plate member 101a, a vehicularly inner side wall facing the trailing arm outer plate member 101b (i.e., a wall portion that is most protruded in the vehicle inward direction when viewed from the trailing arm outer plate member 101b) becomes protrusive toward the trailing arm outer plate member 101b so as to be dented vehicularly outward in the vehicularly lateral direction in a view based on the vehicularly inner side wall surface of the trailing arm inner plate member 101a.

That is, the cross section of the trailing arm inner plate member 101a, at a portion relatively close to the vehicle body-side end thereof, forms a square U shape that is opposite in direction to that of the trailing arm outer plate member 101b, and progressively changes toward a shape in which a wall portion (vehicular inner side wall) of the trailing arm inner plate member 101a that forms the bottom side of the square U cross-sectional shape is protruded (has a protrusive shape) vehicularly outward (toward the outer plate member 101b), with approach toward the wheel-side end.

The vehicularly lateral protuberance of the vehicularly inner side wall of the trailing arm inner plate member 101a toward the outer plate member 101b progressively expands in the width in the vehicularly up-down direction with approach toward the wheel-side end. Also with approach toward the wheel-side end, the degree of vehicularly lateral protuberance toward the trailing arm outer plate member 101b increases. Finally at the wheel-side end of the trailing arm 101, as shown in FIG. 1 and FIG. 3 showing a cross-sectional shape taken on line III-III of FIG. 1, a vehicularly outward protruded portion of the trailing arm inner plate member 101a becomes parallel to the trailing arm outer plate member 101b in the longitudinal direction. Thus the two plate members are closely attached to each other to function as one platy structure.

A bush collar 102 is fitted to the vehicle body-side end of the trailing arm 101, for example, by welding, and is fixed to vehicle body (frame) via an elastic member such as a bush or the like (not shown).

The size and the area of a platy portion 103 formed in the wheel-side end of the trailing arm 101 are designed so that the platy portion 103 functions as an axle bearing mount surface equivalently to the axle carrier in the related-art structure. Besides, the platy portion 103 has a through-hole 104 through which a drive shaft is passed.

Thus, in this embodiment, by pressing the trailing arm inner plate member 101a into a shape as shown in the drawings and described above, and joining it with the trailing arm outer plate member 101b, it is possible to realize a trailing arm that has a hollow shape at a vehicle body-side end, and that includes, in the wheel-side end, the platy portion that functions equivalently to the related-art axle carrier to fit the axle bearing, that is, realize an axle carrier function-integrated type trailing arm.

Therefore, according to the embodiment, since the wheel-side end of the trailing arm 101 has the integrally-formed axle bearing mount surface 103 that functions equivalently to the related-art axle carrier, weight reduction of the trailing type suspension structure can be achieved, in comparison with the related-art structure in which a separate axle carrier is welded to the wheel-side end of the trailing arm 101.

Besides, by providing the suspension structure according to the embodiment, a space on the inner side of the platy portion in the lateral direction of the vehicle can be secured because no member in association with the trailing arm or the axle is disposed in the space. Therefore, that space can be utilized to dispose a drive shaft (not shown) or route an ABS sensor harness, and it becomes possible to adopt a common trailing arm type suspension structure in four-wheel drive vehicles and two-front-wheel drive vehicles, and to improve the ease of the connector mating and demating of the ABS sensor harness or the like.

Furthermore, according to the embodiment, the axle carrier-integrated type trailing arm 101 is formed simply by weld-fixing the trailing arm inner plate member 101a and the outer plate member 101b along the longitudinal direction of the trailing arm 101. Thus, the welding operation is easy, and the production cost reduces, in comparison with the related-art structure in which a tubular trailing arm is weld-fixed to a separate platy axle carrier.

In the first embodiment, the trailing arm inner plate member 101a and the trailing arm outer plate member 101b are formed by a pressing process beforehand so that, when joined, the trailing arm inner plate member 101a and the outer plate member 101b form an arm portion having a hollow shape, and a platy axle bearing mount portion, and then the two members are actually joined to form the trailing arm 101. However, the invention is not limited to this form. For example, it is allowable to form a trailing arm equivalent in function and performance to that of the first embodiment by starting with an integral pipe component and crushing an end of the pipe component by plastic deformation to form a platy portion that functions as an axle bearing mount surface 103. In this case, the welding operation is not necessary in forming the trailing arm 101.

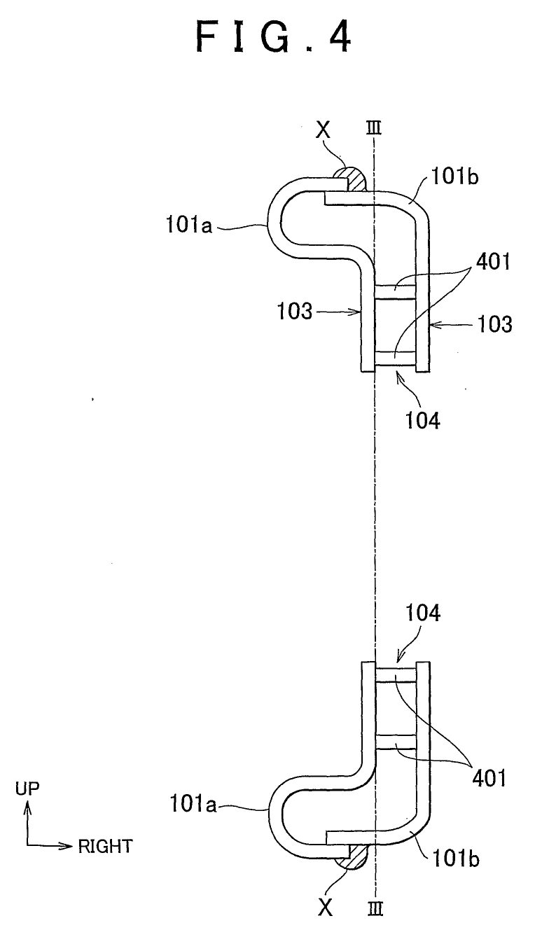

Besides, in the first embodiment, as for the axle bearing mount surface 103, the trailing arm inner plate member 101a and the outer plate member 101b in parallel with each other are closely attached to each other to from an integral platy portion. However, as a modification, it is allowable to provide a construction as shown in FIG. 4 in which joint collars 401 are inserted between parallel portions of the trailing arm inner plate member 101a and the outer plate member 101b to form a uniform clearance and therefore reinforcement is obtained. This reinforcement considerably improves, particularly, the bending rigidity of the axle bearing mount surface 103, which is the platy portion. In addition, the enhancement of the bending rigidity by a reinforcement member such as the joint collars 401 is also applicable in the case where and end of a pipe component that forms the trailing arm 101 is crushed to form the axle bearing mount surface 103.

The invention can be utilized in the trailing arm type suspension structure. As for the vehicles in which the suspension structure of the invention is employed, the exterior, the weight, the size, the running characteristics, etc., do not matter.

While the invention has been described with reference to what are considered to be preferred embodiments thereof, it is to be understood that the invention is not limited to the disclosed embodiments or constructions. On the contrary, the invention is intended to cover various modifications and equivalent arrangements. In addition, while the various elements of the disclosed invention are shown in various combinations and configurations, which are exemplary, other combinations and configurations, including more, less or only a single element, are also within the spirit and scope of the invention.

1-5. (canceled)

6: A vehicular trailing arm type suspension structure comprising:
a trailing arm formed by arranging and joining a first half trailing arm plate member and a second half trailing arm plate member in a longitudinal direction,
wherein the first half trailing arm plate member and the second half trailing arm plate member are formed so that, when the first half trailing arm plate member and the second half trailing arm plate member are joined, a predetermined length portion in the trailing arm relatively close to a vehicle body-side end of the trailing arm in the longitudinal direction has a hollow shape, and a predetermined length portion in the trailing arm relatively close to a wheel-side end of the trailing arm in the longitudinal direction is platy so as to allow a use as an axle bearing mount surface.

7: The trailing arm type suspension structure according to claim 6, wherein a cross-sectional shape of the first half trailing arm plate member is a generally square U shape, and a cross-sectional shape of the second half trailing arm plate member changes along the longitudinal direction from a shape dented with respect to the first half trailing arm plate member at a portion relatively close to the vehicle body-side end of the trailing arm which has a hollow shape, to a shape protruded with respect to the first half trailing arm plate member at a platy portion relatively close to the wheel-side end of the trailing arm.

8: The trailing arm type suspension structure according to claim 6, wherein at the platy portion, the first half trailing arm plate member and the second half trailing arm plate member are closely attached.

9: The trailing arm type suspension structure according to claim 7, wherein at the platy portion, the first half trailing arm plate member and the second half trailing arm plate member are closely attached.

10: The trailing arm type suspension structure according to claim 6, wherein at the platy portion, a reinforcement member is inserted so as to form a clearance between the first half trailing arm plate member and the second half trailing arm plate member.

11: The trailing arm type suspension structure according to claim 7, wherein at the platy portion, a reinforcement member is inserted so as to form a clearance between the first half trailing arm plate member and the second half trailing arm plate member.

12: The trailing arm type suspension structure according to claim 8, wherein at the platy portion, a reinforcement member is inserted so as to form a clearance between the first half trailing arm plate member and the second half trailing arm plate member.

13: The trailing arm type suspension structure according to claim 9, wherein at the platy portion, a reinforcement member is inserted so as to form a clearance between the first half trailing arm plate member and the second half trailing arm plate member.

14: A vehicular trailing arm type suspension structure comprising:
a trailing arm formed by plastic-deforming a portion of a wheel-side end of a hollow tubular trailing arm into a platy portion usable as an axle bearing mount surface, by crushing the portion.
